(19) United States
(12) Patent Application Publication
(10) Pub. No.: US 2010/0182700 A1
(43) Pub. Date: Jul. 22, 2010

(54) LOW STRAY LIGHT VEILING GLARE OBJECTIVE LENS FOR NIGHT VISION SYSTEMS

(75) Inventors: Nils I. THOMAS, Eagle Rock, VA (US); Rekha DOSHI, Londonderry, NH (US); Donald J. JANECZKO, Fincastle, VA (US)

Correspondence Address: RATNERPRESTIA, P.O. BOX 980, VALLEY FORGE, PA, 19482, US

(73) Assignee: ITT MANUFACTURING ENTERPRISES, INC., Wilmington, DE (US)

(21) Appl. No.: 12/357,729

(22) Filed: Jan. 22, 2009

(51) Int. Cl. G02B 3/00

(52) U.S. Cl. 359/613

(57) ABSTRACT

A lens includes first and second opposing surfaces extending radially from an optical axis in an optical system for passing light received from an object. The lens includes a peripheral edge extending between the first and second surfaces. A portion of the peripheral edge has at least either a positive slope or a negative slope with respect to the optical axis. The positive or negative slope of the peripheral edge is configured to reduce glare from stray light received from the first surface. A portion of the peripheral edge may be shaped in a sawtooth pattern or an approximate sinusoidal pattern. The peripheral edge of the lens is also configured to direct light that is received from the object toward light traps which are disposed adjacent to the lens.

### BACKGROUND OF THE INVENTION

Veiling glare is a defect manifested by visible areas of light that are disposed outside a field of view of an optical system, when the optical system views a scene having a bright source of light. Veiling glare is distinguished from ghost images, the latter having flares or arcs of light that are disposed inside the field of view of the optical system, due to viewing bright sources.

Night vision goggle systems typically include an amplifier which detects an image from an objective lens and amplifies the image prior to viewing. Veiling glare, caused by reflections from the lens mounting system, lens edges and lens surfaces, may also be amplified prior to viewing, masking real targets and objects having an output signal smaller than the veiling glare signal.

Conventional veiling glare mitigation techniques in night vision systems include “blackening” edges of lens elements in the objective lens with ink or paint. For example, U.S. Pat. No. 4,961,025 describes a method for blackening a face plate to absorb off axis light entering a night vision tube. U.S. Pat. No. 4,989,960 describes a method for forming a blackened layer in an outer portion of an optical lens by causing hydrogen under pressure to react during a time period and a predetermined temperature range (hydrogen fired) with a metal oxide of the optical material.

### SUMMARY OF THE INVENTION

The present invention includes a lens having first and second opposing surfaces extending radially from an optical axis in an optical system. The lens is configured for passing light received from an object. The lens includes a peripheral edge extending between the first and second surfaces. A portion of the peripheral edge has at least either a positive slope or a negative slope with respect to the optical axis. The positive or negative slope of the peripheral edge is configured to reduce glare from stray light received from the first surface. A portion of the peripheral edge may be shaped in a sawtooth pattern or an approximate sinusoidal pattern. The lens may also include a peripheral edge that has a zero slope.

Light traps may be disposed adjacent to the lens. The peripheral edge of the lens is configured to direct light that is received from the object toward the light traps. Since the light at the periphery of the lens is directed toward the light traps, less veiling glare is seen by the viewer.

The present invention further provides a lens assembly. The lens assembly includes a plurality of lenses disposed along an optical axis. Each lens includes first and second surfaces extending radially from the optical axis for passing light from an object to a viewer. Each lens includes a peripheral edge extending between respective first and second surfaces. A peripheral edge of at least one of the lenses includes a portion having either a positive slope or a negative slope with respect to the optical axis. The positive or negative slope of the peripheral edge is configured to reduce glare to stray light received from the first surface and transmitted toward the second surface of the one lens.

A portion of the peripheral light may be trapped by light traps that are disposed adjacent to some of the lenses. The positive or negative slope of the peripheral edges of the lenses are configured to direct the peripheral light toward the light traps and be captured therein, thereby reducing glare to the viewer.

### BRIEF DESCRIPTION OF THE DRAWINGS

FIG. 1 is a cross sectional view of prior art lenses and a face plate having blackened edges.

FIG. 2A is a cross sectional view of a lens assembly according to an embodiment of the present invention.

FIG. 2B is a cross sectional view of a lens assembly including a lens and light traps, illustrating light reflected from edges of the lens into the traps according to an embodiment of the present invention.

FIG. 2C is a cross sectional view of a lens assembly, illustrating light reflected and backscattered from edges of a lens according to an embodiment of the present invention.

FIG. 3 is a cross sectional view of a doublet lens according to an exemplary embodiment of the present invention.

FIG. 4 is a cross sectional view of a lens having a beveled peripheral edge shaped in a sawtooth pattern according to an exemplary embodiment of the present invention.

FIG. 5 is a cross sectional view of a lens having a beveled peripheral edge shaped having an approximate sinusoidal pattern according to an exemplary embodiment of the present invention.

FIG. 6 is a cross-sectional view of a lens having a beveled peripheral edge shaped lens having an approximate sawtooth pattern with sinusoidal tips according to an exemplary embodiment of the present invention.

FIG. 7 is a cross sectional view of a lens having a non-beveled peripheral edge shaped in a sawtooth pattern according to an exemplary embodiment of the present invention.

FIG. 8 is a cross-sectional view of a lens having a non-beveled peripheral edge having an approximate sinusoidal pattern according to an exemplary embodiment of the present invention.

FIG. 9 is a cross sectional view of a lens with beveled peripheral edges having different slopes according to an exemplary embodiment of the present invention.

### DETAILED DESCRIPTION OF THE INVENTION

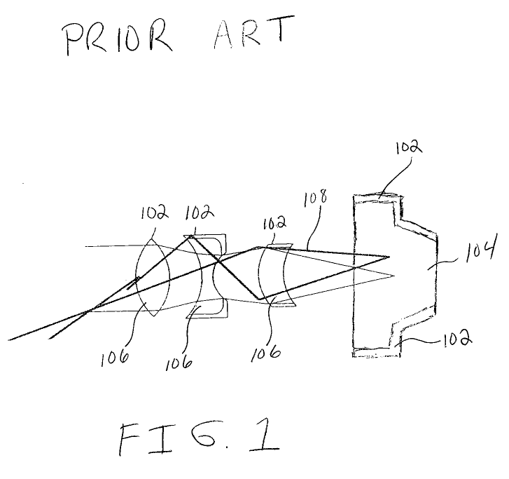

The “blackened” edges described in conventional systems are partially absorbent and scatter any unabsorbed light into the field of view of the lens system causing veiling glare. FIG. 1 shows different prior art lenses 106 including face plate 104 having blackened edges 102. While edges 102 are blackened with an absorbing ink, light energy may not be effectively absorbed by the ink. As shown in FIG. 1, light energy 108 reflects off from blackened edges 102, causing veiling glare.

Hydrogen firing of lenses for veiling glare reduction may absorb additional light energy. Unfortunately, the types of glass which may be selected for hydrogen firing are limited. Furthermore, the edges of lenses that are hydrogen fired to form blackened surfaces having the same index of refraction require additional processing and edge grinding.

Although hydrogen fired blackened edges may absorb large amounts of light in the blue, green and red spectral regions, these edges are transmissive in the near infrared (IR) region where most night vision goggles operate. Accordingly, care in design is required to make a low veiling glare objective lens when using a near IR detector, such as a night vision tube. Hydrogen firing of glass edges is also costly and difficult to achieve.

The present invention, on the other hand, reduces veiling glare by changing the shape of the edge of a lens. As will be explained, the edge of a lens may be shaped to cause light to reflect and backscatter through the front of the lens or cause the light to be directed toward light traps built into the lens assembly for trapping the re-directed light.

Exemplary lens edges may shaped in different ways to reduce veiling glare. For example, lens edges may be beveled, and shaped in a sawtooth pattern, or in an approximate sinusoidal pattern. In addition, it is contemplated that other lens edge shapes may be used to backscatter light through the front of a lens or trap light within a lens assembly.

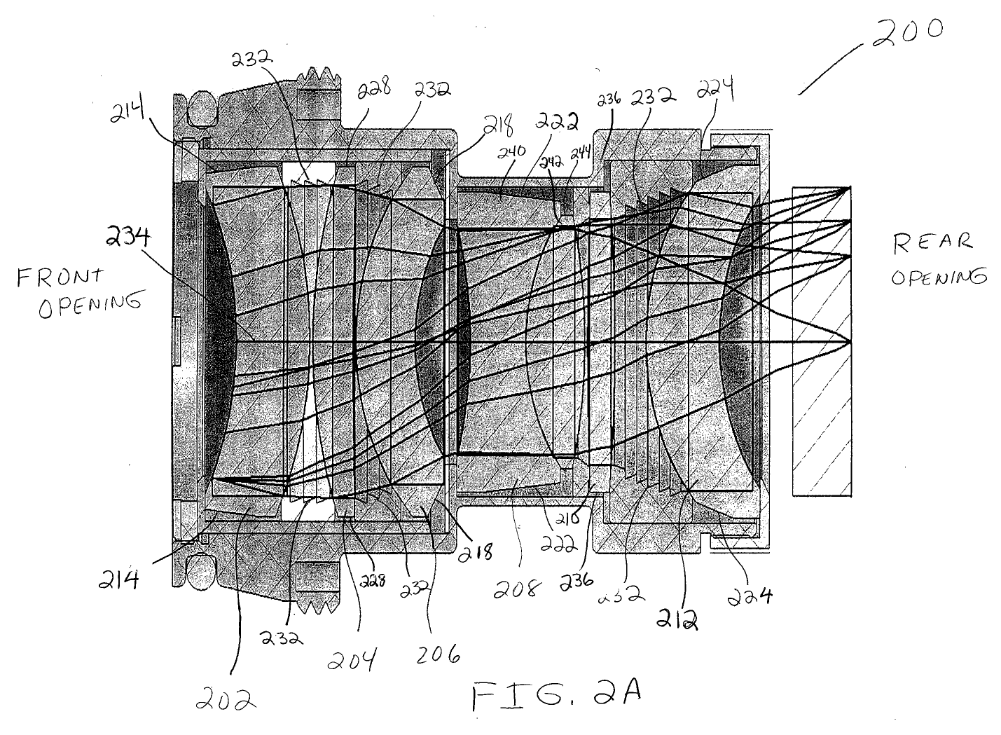

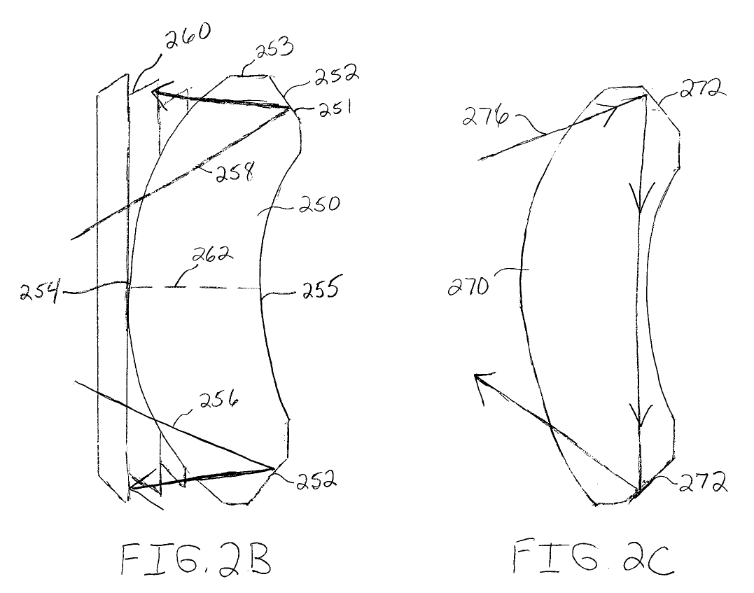

FIG. 2A is a cross sectional view of lens assembly 200 according to an exemplary embodiment of the present invention. Lens assembly 200 includes a plurality of lenses 202-212. The number of lenses, as well as their size, shape and position are illustrative and not limiting.

Lens assembly 200 also includes a plurality of light traps 232, positioned for trapping light that is scattered from the peripheral edges of lenses 202-212. As shown in FIG. 2, for example, light traps 232 are positioned on top and bottom sides of lens assembly 200 between lenses 202 and 204. Light traps are also positioned between lenses 204 and 206, as well as between lenses 210 and 212. The number of light traps, as well as the size, shape and position of the light traps are illustrative and not limiting. It is contemplated within the scope of the present invention that light traps may be positioned in different areas of an exemplary lens assembly depending on the positions and shapes of lenses disposed within the lens assembly.

It will be appreciated that the peripheral edges of the lenses are configured to direct light reflected from the peripheral edges toward the light traps. By actively and purposely configuring the peripheral edges of the lenses so that light is directed toward the light traps, the present invention achieves a reduction of veiling glare, because much stray light reflected from the peripheral edges become trapped within the light traps.

As shown in FIG. 2A, lens assembly 200 includes optical axis 234. Lens 202 includes a beveled peripheral edge 214, illustrated on the top and bottom portions of lens 202. Peripheral edge 214 slopes toward optical axis 234 as the edge approaches the front opening of lens assembly 200. That is, peripheral edge 214 has a positive slope with respect to optical axis 234.

Peripheral edge 224 of lens 212 is also beveled in the same direction as peripheral edge 214 of lens 202. The slope of peripheral edge 224, however, is steeper than the slopes of edges 214 and 216.

Peripheral edge 218 of lens 206 is beveled in a direction opposite that of beveled peripheral edges 214 and 224. That is, peripheral edge 218 has a negative slope with respect to optical axis 234. Lastly, peripheral edge 222 of lens 208 also has a negative slope with respect to optical axis 234.

The degree of inclination and direction of each slope of the peripheral edges shown in FIG. 2A are illustrative and not limiting. In another configuration, only a portion of a peripheral edge may have a positive slope or a negative slope with respect to the optical axis; the remaining portion of the peripheral edge may be non-beveled, or may slope in a negative or a positive direction with respect to the optical axis. The degree of inclination and direction of the slope may depend on different factors, such as, for example, the size and position of each lens within the lens assembly, the shapes of edges of other lenses and the number of lenses in the lens assembly. In addition, the slope may also depend on the light ray tracing relationship between a peripheral edge of a lens and its corresponding light trap. Any of these factors may be used to shape the edge of a lens for backscattering light through the front of a lens or for trapping light within the lens assembly.

In the example shown in FIG. 2A, two lenses are not beveled. As shown, peripheral edge 228 of lens 204 and peripheral edge 236 of lens 210 are not beveled.

FIG. 2B is a cross sectional view of a lens and light traps both disposed within a lens assembly for illustrating light reflected from edges of the lens into the light traps according to an embodiment of the present invention. As shown, lens 250 includes first surface 254 extending radially from optical axis 262 for transmitting light rays 256 and 258, which have been received from an object (not shown). Also shown is an opposing second surface 255 extending radially from optical axis 262 for transmitting light rays 256 and 258, which have been received from first surface 254 and a beveled peripheral edge 252 extending between first surface 254 and second surface 255.

As shown at FIG. 2B, surface portion 251 of peripheral edge 252 is beveled and another surface portion 253 of peripheral edge 252 is not beveled. That is, surface portion 251 has a negative slope with respect to optical axis 234. Surface portion 253 has a zero slope with respect to optical axis 234. The ratio of the beveled portion to the non-beveled portion is illustrative and not limiting. It is contemplated that a peripheral edge of a lens may have any ratio of beveled portion to non-beveled portion that is sufficient to direct light, so that it is effectively trapped within the lens assembly or backscattered out of the lens assembly.

Light traps 260, shown in FIG. 2B, are positioned adjacent to lens 250. Light rays 256 and 258 reflect from beveled peripheral edge 252 at the top and bottom portions of lens 250 and are directed into light traps 260, trapping light rays 256 and 258 within the lens assembly. It is contemplated that light may be re-directed from any portion of a peripheral edge of a lens so that it is backscattered into a light trap.

Alternatively, peripheral edges of a lens may be shaped to cause light to be backscattered out through the lens and out of the lens assembly. FIG. 2C is a cross sectional view of a lens within a lens assembly illustrating a light ray that is reflected from a peripheral edge of the lens and backscattered out of the lens according to an embodiment of the present invention. As shown in FIG. 2C, lens 270 includes a beveled peripheral edge 272. Light ray 276 reflects from beveled peripheral edge 272 and is backscattered out through lens 270 and out of the lens assembly (not shown).

The angles at which light rays reflect from peripheral edges 252 and 272 in FIGS. 2B and 2C are illustrative and not limiting.

An exemplary lens may include multiple lenses coupled together, such as, a lens doublet or a lens triplet, respectively. For example, lens 208 of lens assembly 200 includes first lens 240 and second lens 242 coupled together, forming a doublet. As shown in FIG. 2A, an edge of first lens 240 of doublet 208 includes beveled peripheral edge 220. Second lens 242 of doublet 208, however, includes a non-beveled peripheral edge 244.

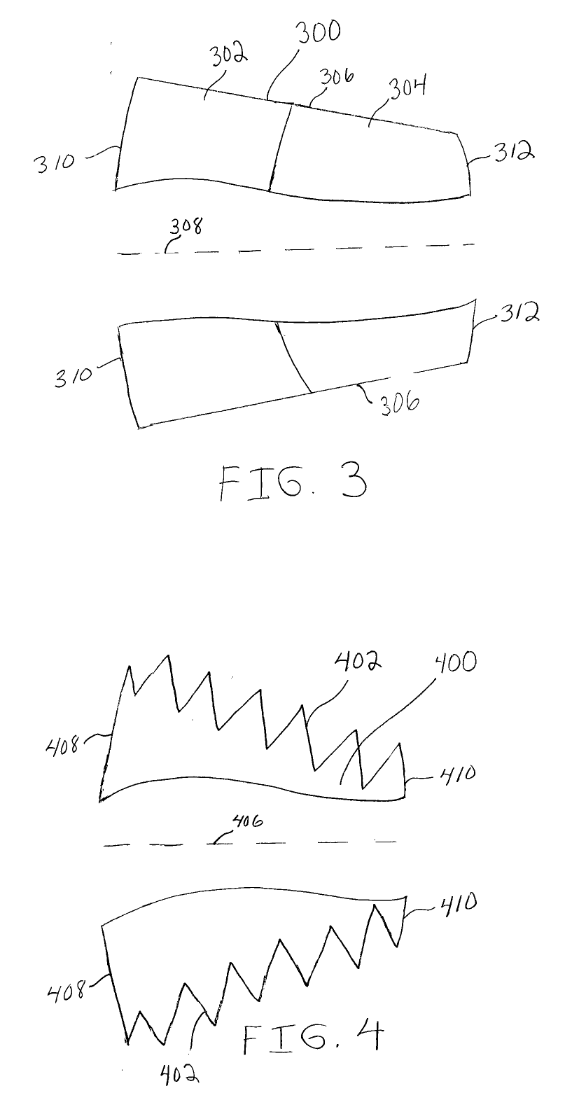

FIG. 3 is a cross sectional view of top and bottom portions of a doublet according to an exemplary embodiment of the present invention. Doublet lens 300 includes optical axis 308. Doublet lens 300 also includes first surface 310 extending radially from optical axis 308 for transmitting light received from an object (not shown). Doublet lens 300 also includes second surface 312, which is opposite first surface 310 and extends radially from optical axis 308, for passing light received from first surface 310.

As shown in FIG. 3, peripheral edge 306, shown on the top and bottom portions of lenses 302 and 304 is a combined peripheral edge that extends from surface 310 to surface 312. Peripheral edge 306 is beveled to slope toward optical axis 308, as the edge approaches surface 312 from surface 310. Alternatively, peripheral edge 306 may be beveled in the opposite direction to slope away from optical axis 308, as the edge approaches surface 312 from surface 310. It is also contemplated that edges of combined lenses may be beveled without forming a single edge. That is, beveled edges of the combined lenses may be offset from each other.

According to an exemplary embodiment of the present invention, a lens assembly may include a lens having a peripheral edge which is both beveled and shaped in a particular pattern. FIGS. 4 through 6 illustrate exemplary lenses having beveled peripheral edges which include particular patterns.

FIG. 4 is a cross sectional view of a lens having a beveled peripheral edge. As shown, lens 400 includes a peripheral edge, which is beveled and shaped in a sawtooth pattern shown as sawtooth pattern 402). That is, peripheral edge 402 slopes toward optical axis 406, as the edge approaches surface 410 from surface 408.

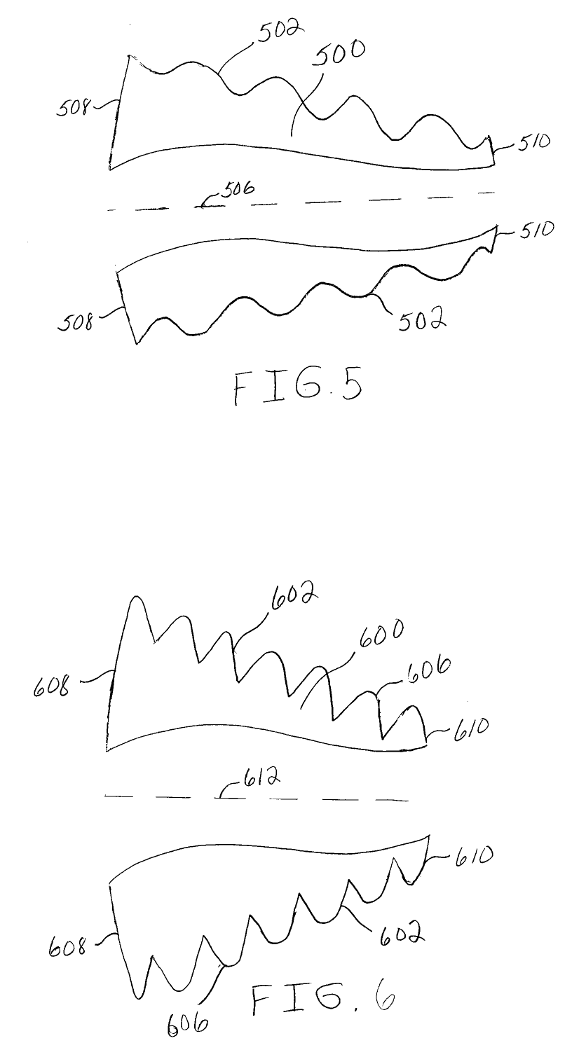

FIG. 5 is an exploded cross sectional view of a beveled peripheral edge shaped in an approximate sinusoidal pattern, according to another exemplary embodiment of the present invention. As shown, lens 500 includes peripheral edge 502, which is beveled and shaped in an approximate sinusoidal pattern.

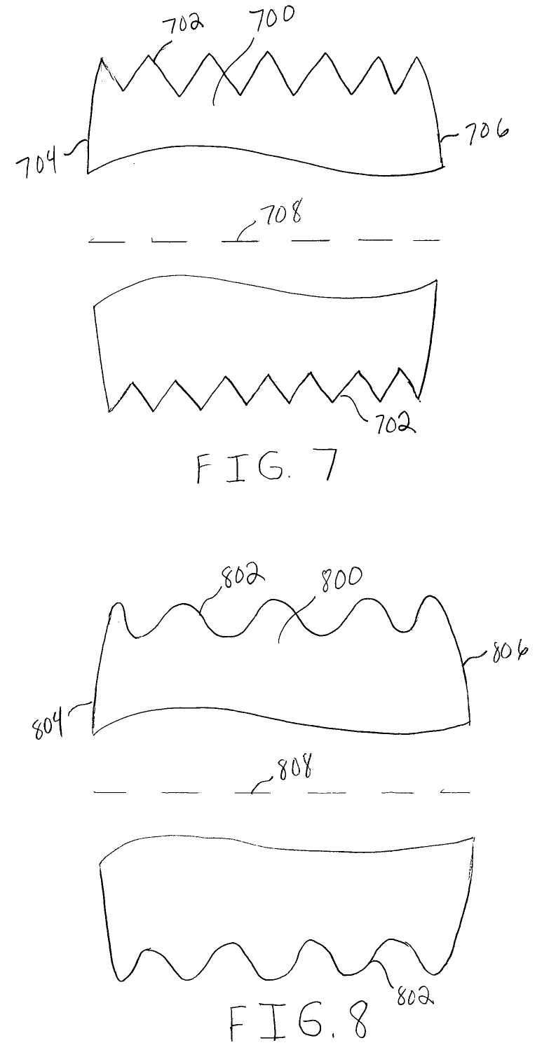

FIG. 6 is an exploded cross sectional view of a beveled peripheral edge shaped in a sawtooth pattern with rounded tips, according to yet another exemplary embodiment of the present invention. As shown, lens 600 includes peripheral edge 602, which is beveled and shaped in a sawtooth pattern with rounded tips formed from an approximate sinusoidal pattern.

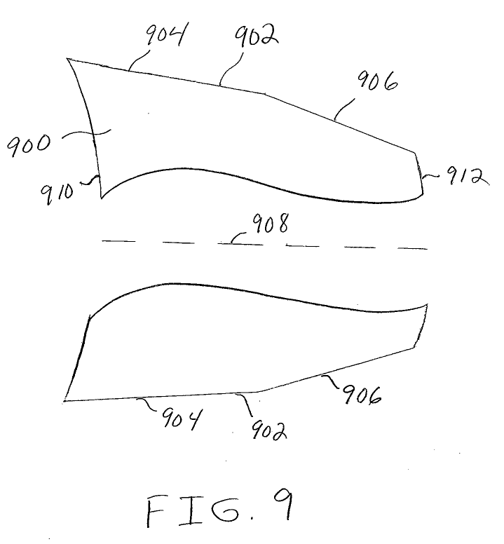

According to still another exemplary embodiment of the present invention, a lens assembly may include a lens having a non-beveled peripheral edge shaped in a pattern, as shown in FIGS. 7 and 8. FIGS. 7 and 8 illustrate the non-beveled edges of lens 700 and 800 respectively shaped in different patterns. Lens 700 includes a peripheral edge which is shaped in a sawtooth pattern, designated as 702 in FIG. 7; or an approximate sinusoidal pattern, designated as 802 in FIG. 8 showing lens 800. As shown in FIG. 7, the peripheral edge of lens 700 has a zero slope, as it extends from surface 704 to surface 706.

FIG. 9 is a cross sectional view of top and bottom portions of a lens in yet another embodiment of the present invention. As shown, lens 900 includes peripheral edge 902 having first portion 904 and second portion 906. First portion 904 has a first slope sloping toward optical axis 908, as it approaches surface 912 from surface 910. Second portion 906 has a second slope, different from the first slope, as it moves toward optical axis 908.

The peripheral edge patterns shown in FIGS. 3 thorough 9 are not limiting. It is contemplated that the edges may be shaped in other patterns which are sufficient for causing light to be backscattered through the front of the lens, or directed to be trapped within light traps placed within the lens assembly.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A lens having an optical axis comprising:
a first surface extending radially from the optical axis for passing light received from an object,
an opposing second surface extending radially from the optical axis for passing light received from the first surface, and
a peripheral edge extending between the first and second surfaces, a portion of the peripheral edge having at least a positive slope or a negative slope with respect to the optical axis,
wherein the positive or negative slope of the peripheral edge is configured to reduce glare from stray light received from the first surface.

2. A lens according to claim 1, wherein
the peripheral edge is shaped in a sawtooth pattern.

3. A lens according to claim 1, wherein
the peripheral edge is shaped in an approximate sinusoidal pattern.

4. A lens according to claim 1, wherein
the peripheral edge is shaped in a sawtooth pattern with a portion of the sawtooth pattern having rounded tips.

5. A lens according to claim 1, wherein
the peripheral edge further includes another portion having a different slope with respect to the optical axis.

6. A lens according to claim 1, wherein
the peripheral edge further includes another portion having a zero slope with respect to the optical axis.

7. A lens according to claim 1, wherein
the portion of the peripheral edge includes a zero slope with respect to the optical axis.

8. A lens having an optical axis comprising:
a first surface extending radially from the optical axis for passing light received from an object,
an opposing second surface extending radially from the optical axis for passing light received from the first surface, and
a peripheral edge extending between the first and second surfaces,
wherein a portion of the peripheral edge is shaped in a pattern that slopes toward and away from the optical axis.

9. A lens according to claim 8, wherein
the pattern is a sawtooth pattern.

10. A lens according to claim 8, wherein
the pattern is an approximate sinusoidal pattern.

11. A lens according to claim 8, wherein
the pattern is a sawtooth pattern with at least portions of the sawtooth pattern having rounded tips.

12. A lens assembly comprising:
a plurality of lenses disposed along an optical axis,
each lens including first and second surfaces extending radially from the optical axis for passing light from an object to a viewer,
each lens including a peripheral edge extending between respective first and second surfaces, and
a peripheral edge of at least one of the lenses includes a portion having at least a positive slope or a negative slope with respect to the optical axis,
wherein the positive or negative slope of the peripheral edge is configured to reduce glare to stray light received from the first surface and transmitted toward the second surface of the at least one of the lenses.

13. A lens according to claim 12, wherein
a light trap is disposed adjacent to at least one of the lenses for capturing the stray light reflected from the peripheral edge.

14. A lens according to claim 12, wherein
the peripheral edge is configured to direct the stray light received from the first surface to the light trap.

15. A lens according to claim 12, wherein
the peripheral edge is configured to reflect the stray light out of the lens assembly.

16. A lens according to claim 12, wherein
the peripheral edge is shaped in a sawtooth pattern.

17. A lens according to claim 12, wherein
the peripheral edge is shaped in an approximate sinusoidal pattern.

18. A lens according to claim 12, wherein
the peripheral edge is shaped in a sawtooth pattern with a portion of the sawtooth pattern having rounded tips.

19. A lens according to claim 12, wherein
the peripheral edge further includes another portion having a different slope with respect to the optical axis.

20. A lens according to claim 12, wherein
the portion of the peripheral edge further includes a zero slope with respect to the optical axis.
